(19) United States
(12) Patent Application Publication
(10) Pub. No.: US 2021/0386096 A1
(43) Pub. Date: Dec. 16, 2021

(54) FEED ADDITIVE TO PROMOTE THE GROWTH OF SOWS AND PIGLETS AND APPLICATION THEREOF

(71) Applicants: LIUQIN HE, Changsha City (CN); TIEJUN LI, Changsha City (CN); YANZHONG FENG, Changsha City (CN); WENJIE TANG, Changsha City (CN); YULONG YIN, Changsha City (CN); JIANZHONG LI, Changsha City (CN); SHENGPING WANG, Changsha City (CN); XINGGUO HE, Changsha City (CN)

(72) Inventors: LIUQIN HE, Changsha City (CN); TIEJUN LI, Changsha City (CN); YANZHONG FENG, Changsha City (CN); WENJIE TANG, Changsha City (CN); YULONG YIN, Changsha City (CN); JIANZHONG LI, Changsha City (CN); SHENGPING WANG, Changsha City (CN); XINGGUO HE, Changsha City (CN)

(21) Appl. No.: 17/347,485

(22) Filed: Jun. 14, 2021

(30) Foreign Application Priority Data
Jun. 15, 2020 (CN) 202010545003.9

(51) Int. Cl. A23K 20/142; A23K 10/30; A23K 50/30

(52) U.S. Cl. CPC A23K 20/142; A23K 50/30; A23K 10/30

(57) ABSTRACT

The present invention provides feed additive to promote the growth of sows and piglets, which comprises serine, astragalus and ginseng leaves. The feed additive preferably contains: 50-60 wt % of the serine, 20-25 wt % of the astragalus, 20-25 wt % of the ginseng leaves and the balance of rice bran meal as a carrier. The invention also provides applications of the above-mentioned feed additive in promoting the growth of sows and piglets, that is, before feeding, make the serine content in the diet reach 0.69 wt % and incorporate it into the diet of gestational sows, and/or make the serine content in the diet reach 0.82 wt % and incorporate it into the diet of lactating sows.

### FIELD OF THE INVENTION

The invention belongs to the technical field of animal nutrition, and specifically relates to feed additive to promote the growth of sows and piglets and applications.

### BACKGROUND OF THE RELATED ART

With the continuous improvement of intensive production of pigs, the immunity of sows has become more and more important. In some countries, the number of sows producing piglets per year is low, the main reason is that their immune function is poor, and they cannot effectively resist the immune stress caused by increased metabolism during pregnancy, delivery and lactation, which further causes the sow's farrowing performance and lactation ability to decline. The reason for the low survival rate of piglets also indicates that piglets have experienced a variety of stress injuries from birth to weaning, the immature immune system is difficult to effectively remove excessive inflammatory factors, resulting in abnormal intestinal function of piglets, affecting the absorption and utilization of nutrients, causing piglets to diarrhea, growth retardation, and even death. The antibodies obtained by pigs from the mother through the placenta or milk (especially colostrum) are called maternal antibodies. Passive immunity through colostrum transmission of maternal antibodies is the main way to improve immunity of newborn piglets, and it is also an important guarantee for the establishment of subsequent active immunity. By improving the immune function of sows during pregnancy and lactation, it can not only improve the reproductive performance of sows, but also enhance the immunity of piglets through maternal transmission and promote the growth of piglets.

Therefore, the breeding of sows and piglets has always been the core key to pig breeding.

### SUMMARY OF THE INVENTION

The purpose of the present invention is to provide a feed additive to promote the growth of sows and piglets, which comprises serine, astragalus and ginseng leaves.

Preferably, the feed additive comprises: 50-60 wt % of the serine, 20-25 wt % of the astragalus, 20-25 wt % of the ginseng leaves and the balance of rice bran meal as a carrier.

Preferably, the feed additive comprises: 50 wt % of the serine, 25 wt % of the astragalus and 25 wt % of the ginseng leaves.

Preferably, the feed additive comprises: 50 wt % of the serine, 20 wt % of the astragalus, 20 wt % of the ginseng leaves and 10 wt % of the rice bran meal.

Preferably, the feed additive comprises: 55 wt % of the serine, 20 wt % of the astragalus, 20 wt % of the ginseng leaves, and 5 wt % of the rice bran meal.

Preferably, the feed additive comprises: 60 wt % of the serine, 20 wt % of the astragalus, and 20 wt % of the ginseng leaves.

Preferably, the feed additive comprises: 50 wt % of the serine, 22 wt % of the astragalus, 22 wt % of the ginseng leaves, and 6 wt % of the rice bran meal.

Preferably, the feed additive comprises: 50 wt % of the serine, 23 wt % of the astragalus, 23 wt % of the ginseng leaves, and 4 wt % of the rice bran meal.

The invention also provides applications of any of the above feed additives, the feed additive is incorporated into the pig diet before feeding.

Preferably, before feeding, make the serine content in the diet reach 0.69 wt %˜1.1 wt %, and incorporate it into the diet of gestational sows, and/or make the serine content in the diet reach 0.82 wt %˜1.32 wt %, and incorporate it into the diet of lactating sows.

The feed additive of the invention can effectively improve the immune function of sows and piglets and promote the growth of sows and piglets.

### DETAILED DESCRIPTION OF THE PREFERRED EMBODIMENTS

The present invention will be further described below in conjunction with specific embodiments, and the advantages and features of the present invention will become clearer with the description. However, it should be understood that the embodiments are only exemplary and do not limit the scope of the present invention. Those skilled in the art should understand that the details and forms of the technical solution of the present invention can be modified or replaced without departing from the spirit and scope of the present invention, but these modifications and replacements fall within the protection scope of the present invention.

In the following description, the methods involved are conventional methods in the art unless otherwise specified. Unless otherwise specified, the raw materials involved are all raw materials that can be obtained from open commercial channels.

Serine is one of the 20 amino acids that make up protein, it is a neutral aliphatic amino acid containing hydroxyl groups, it plays a role in the metabolism of fat, fatty acids and muscle growth, and it also contributes to the production of immune blood cells and antibodies.

Astragalus (scientific name: Astragalus propinquus Schischkin) is a plant of the legume Astragalus genus. Astragalus contains saponins, sucrose, polysaccharides, various amino acids, folic acid, selenium, zinc, copper and other trace elements.

Ginseng leaves are dried leaves of Panax ginseng C. A. Mey., a plant of the Araliaceae family, which contains a variety of saponins and vitamins B1, B2, and C.

The present invention mixes serine, astragalus, and ginseng leaves according to a certain ratio to obtain a novel feed additive, which is suitable for being incorporated into the diet of pigs to help improve the immune function of growing pigs.

### Embodiment 1: Feed Additive

The formula of the feed additive of this embodiment is as follows: 50 wt % of the serine, 25 wt % of the astragalus and 25 wt % of the ginseng leaves.

Firstly, astragalus and ginseng leaves are ground into powder separately, and then mixed them with serine powder uniformly to make a powder feed additive.

### Embodiment 2: Feed Additive

The formula of the feed additive of this embodiment is as follows: 50 wt % of the serine, 20 wt % of the astragalus, 20 wt % of the ginseng leaves and 10 wt % of the rice bran meal.

Firstly, astragalus and ginseng leaves are ground into powder, and then mixed them with serine and rice bran meal to make a powder feed additive.

### Embodiment 3: Feed Additive

The formula of the feed additive of this embodiment is as follows: 55 wt % of the serine, 20 wt % of the astragalus, 20 wt % of the ginseng leaves, and 5 wt % of the rice bran meal.

Firstly, astragalus and ginseng leaves are ground into powder, and then mixed them with serine and rice bran meal to make a powder feed additive.

### Embodiment 4: Feed Additive

The formula of the feed additive of this embodiment is as follows: 60 wt % of the serine, 20 wt % of the astragalus, and 20 wt % of the ginseng leaves.

Firstly, astragalus and ginseng leaves are ground into powder, and then mixed them with serine powder uniformly to make a powder feed additive.

### Embodiment 5: Feed Additive

The formula of the feed additive of this embodiment is as follows: 50 wt % of the serine, 22 wt % of the astragalus, 22 wt % of the ginseng leaves, and 6 wt % of the rice bran meal.

Firstly, astragalus and ginseng leaves are ground into powder, and then mixed them with serine powder and rice bran meal to make a powder feed additive.

### Embodiment 6: Feed Additive

The formula of the feed additive of this embodiment is as follows: 50 wt % of the serine, 23 wt % of the astragalus, 23 wt % of the ginseng leaves, and 4 wt % of the rice bran meal.

Firstly, astragalus and ginseng leaves are ground into powder, and then mixed them with serine powder and rice bran meal to make a powder feed additive.

### Embodiment 7: the Effect of Feed Additive on Pig Growth

Take the feed additive prepared in the embodiment 2 as an example to evaluate the effect of the feed additive of the present invention on the growth of sows and piglets.

A selection of 40 sows with the second parity and a weight of 150±15kg grown on 85 days of gestation were randomly divided into four treatment groups, including the control group and three experimental groups, each with 10 replicates, each replicated 1 sow. The test was divided into two stages. The first stage was from the 85th day of pregnancy to prenatal, a total of about 30 days, and the second stage was from the day of delivery to 7 days after the suckling piglets were weaned, piglets were weaned at 21 days of age, so the second phase of the trial was 28 days in total.

The basal diet was corn-soybean meal type diet, the control group was fed with basal diet, and each experimental group was fed with different test diets, the test diet was based on the basic diet with different proportions of feed additives. In the first stage, the experimental diet of the first experimental group was supplemented with 1.38 wt % feed additive on the basis of the basic diet (at this time the content of serine in the diet reached 0.69 wt %), the experimental diet of the second experimental group was supplemented with 1.65 wt % feed additive on the basis of the basic diet (at this time the content of serine in the diet reached 0.825 wt %), the experimental diet of the third experimental group was supplemented with 2.2 wt % feed additive on the basis of the basic diet (at this time the content of serine in the diet reached 1.1 wt %). In the second stage, the experimental diet of the first experimental group was based on the basic diet with 1.65 wt % feed additive (at this time the content of serine in the diet reached 0.825 wt %), the experimental diet of the second experimental group was supplemented with 1.98 wt % feed additive on the basis of the basic diet (at this time the content of serine in the diet reached 0.995 wt %), the experimental diet of the third experimental group was supplemented with 2.64 wt % feed additive on the basis of the basic diet (at this time the content of serine in the diet reached 1.32 wt %).

The feeding conditions of each group were kept consistent, and the sows were fed with free intake and free water to keep the trough clean and the freshness of the feed.

The health status of the sow and piglet herd was observed and recorded every day. Reproductive performance indicators, such as the birth process on the day of delivery (i.e. the time from the first to the last), the total number of piglets in a farrow, the number of live piglets in a farrow, the number of healthy piglets in a farrow, the number of dead piglets in a farrow, the weight of a farrow at birth, the weight of newborn piglets, etc. were recorded, and the results are shown in Table 1.

The piglets were cross-bred within 24 hours after the sows gave birth, and the number of piglets per farrow was adjusted to 10. The health status of the piglet herd was observed, on the 11th day after delivery, the piglet's farrow weight was weighed and the average piglet weight was calculated, on the 21st day, the number of piglets weaned from the farrow was observed and recorded, the weight of the farrow was recorded, and the average piglet weight was calculated, on the 21st day, the piglets were weaned, within 21 days of lactation, the piglets did not feed the trough but only sucked milk to ensure the unity of maternal nutrient delivery.

Table 1 growth and reproduction of sows and growth of piglets

| | Control | | Experimental | | Experimental | | Experimental | | P |
|---|---|---|---|---|---|---|---|---|---|
| | Group | | Group I | | Group II | | Group III | | Value |
| Feed intake during | 4.04 ± | 0.00^{b} | 4.19 ± | 0.02^{a} | 3.95 ± | 0.00^{c} | 4.01 ± | 0.04^{bc} | 0 |
| pregnancy(kg/day) | | | | | | | | | |
| Feed intake during | 5.43 ± | 0.06^{c} | 6.38 ± | 0.05^{a} | 6.12 ± | 0.02^{b} | 6.09 ± | 0.03^{b} | 0 |
| lactation(kg/day) | | | | | | | | | |
| Birth process(hour) | 3.77 ± | 0.22^{b} | 4.17 ± | 0.34^{b} | 4.48 ± | 0.15^{ab} | 5.12 ± | 0.40^{a} | 0.013 |
| The total number of | 13.63 ± | 0.27^{ab} | 12.95 ± | 0.24^{b} | 14.00 ± | 0.28^{a} | 13.79 ± | 0.26^{a} | 0.034 |
| farrowing | | | | | | | | | |
| The number of live | 13.40 ± | 0.16^{a} | 12.47 ± | 0.27^{b} | 13.30 ± | 0.15^{a} | 13.15 ± | 0.25^{ab} | 0.028 |
| piglets in a farrow | | | | | | | | | |
| The number of | 12.24 ± | 0.11^{a} | 11.69 ± | 0.12^{b} | 12.36 ± | 0.15^{a} | 12.42 ± | 0.15^{a} | 0 |
| healthy piglets | | | | | | | | | |
| The weight of a | 17.82 ± | 0.30^{b} | 19.41 ± | 0.41^{a} | 18.39 ± | 0.33^{ab} | 18.46 ± | 0.49^{ab} | 0.045 |
| farrow of healthy | | | | | | | | | |
| piglets at | | | | | | | | | |
| birth(kg/farrow) | | | | | | | | | |
| The average weight | 1.47 ± | 0.02^{b} | 1.69 ± | 0.02^{a} | 1.48 ± | 0.03^{b} | 1.55 ± | 0.05^{b} | 0 |
| of healthy piglets at | | | | | | | | | |
| birth (kg/each one) | | | | | | | | | |
| The weight of a | 38.69 ± | 0.90^{c} | 48.29 ± | 1.00^{a} | 44.40 ± | 1.12^{b} | 44.15 ± | 1.02^{b} | 0 |
| farrow of 11th | | | | | | | | | |
| day(kg/farrow) | | | | | | | | | |
| The average weight | 3.60 ± | 0.05^{c} | 4.27 ± | 0.08^{a} | 4.05 ± | 0.09^{ab} | 3.94 ± | 0.08^{b} | 0 |
| of 11th day(kg/each | | | | | | | | | |
| one) | | | | | | | | | |
| The weight of a | 64.74 ± | 1.28^{c} | 75.4 ± | 1.44^{a} | 69.0 ± | 2.03^{bc} | 70.86 ± | 1.86^{ab} | 0.001 |
| farrow at | | | | | | | | | |
| weaning(kg/farrow) | | | | | | | | | |
| The number of | 10.00 ± | 0.26 | 10.79 ± | 0.24 | 10.54 ± | 0.33 | 10.77 ± | 0.28 | 0.23 |
| weaned piglets | | | | | | | | | |
| The average weight | 6.25 ± | 0.11^{c} | 7.12 ± | 0.09^{a} | 6.65 ± | 0.12^{b} | 6.61 ± | 0.13^{b} | 0 |
| at weaning | | | | | | | | | |
| (kg/each one) | | | | | | | | | |

Remarks:
1. The total number of piglets includes the number of live piglets in a farrow and the number of weak piglets, deformed piglets, stillbirths, and mummies;
2. The number of live piglets in a farrow includes the number of healthy and weak piglets;
3. The number of healthy piglets in a farrow includes the number of piglets weighing more than 0.9 kg in good growth condition.

From the results in Table 1, it can be seen that compared with the control group, the daily feed intake of the sows in the three experimental groups and average weight of the weaned healthy piglets in a farrow overlapped all showed an increase, especially the first experimental group showed a significant improvement. In the 11 and 21 days after the piglets were born, compared with the control group, the farrow weight and average body weight of each experimental group with feed additive added to the diet were relatively good, especially the growth performance of piglets in the first experimental group was better.

This shows that the feed additive used in the experiment can effectively promote the growth of sows and piglets. When used to promote the growth of gestational sows, it is preferred to incorporate the feed additive of the present invention into the diet so that the serine content in the diet reaches 0.69 wt %, when used to promote the growth of lactating sows, it is preferred to incorporate the feed additive of the present invention into the diet so that the serine content in the diet reaches 0.825 wt %.

The above are only the preferred embodiments of the present invention, and the protection scope of the present invention is not limited to the above-mentioned embodiments, and all technical solutions under the idea of the present invention belong to the protection scope of the present invention. For those of ordinary skill in the art, improvements and modifications without departing from the principle of the present invention should also be regarded as falling within the protection scope of the present invention.

1. A feed additive to promote the growth of sows and piglets, which comprises serine, astragalus and ginseng leaves.

2. The feed additive according to claim 1, wherein the feed additive comprises: 50-60 wt % of the serine, 20-25 wt % of the astragalus, 20-25 wt % of the ginseng leaves and the balance of rice bran meal as a carrier.

3. The feed additive according to claim 2, wherein the feed additive comprises: 50 wt % of the serine, 25 wt % of the astragalus and 25 wt % of the ginseng leaves.

4. The feed additive according to claim 2, wherein the feed additive comprises: 50 wt % of the serine, 20 wt % of the astragalus, 20 wt % of the ginseng leaves and 10 wt % of the rice bran meal.

5. The feed additive according to claim 2, wherein the feed additive comprises: 55 wt % of the serine, 20 wt % of the astragalus, 20 wt % of the ginseng leaves, and 5 wt % of the rice bran meal.

6. The feed additive according to claim 2, wherein the feed additive comprises: 60 wt % of the serine, 20 wt % of the astragalus, and 20 wt % of the ginseng leaves.

7. The feed additive according to claim 2, wherein the feed additive comprises: 50 wt % of the serine, 22 wt % of the astragalus, 22 wt % of the ginseng leaves, and 6 wt % of the rice bran meal.

8. The feed additive according to claim 2, wherein the feed additive comprises: 50 wt % of the serine, 23 wt % of the astragalus, 23 wt % of the ginseng leaves, and 4 wt % of the rice bran meal.

9. The application of the feed additive according to any one of claims 1-8, the feed additive is incorporated into the pig diet before feeding.

10. The feed additive according to claim 9, wherein that is, before feeding, make the serine content in the diet reach 0.69 wt %˜1.1 wt %, and incorporate it into the diet of gestational sows, and/or make the serine content in the diet reach 0.82 wt %˜1.32 wt %, and incorporate it into the diet of lactating sows.
